(19) United States
(12) Patent Application Publication
(10) Pub. No.: US 2017/0202190 A1
(43) Pub. Date: Jul. 20, 2017

(54) ENCLOSURE LID USEFUL WITH AN AQUARIUM

(71) Applicant: Rick Wascher, Bartlett, TN (US)

(72) Inventor: Rick Wascher, Bartlett, TN (US)

(21) Appl. No.: 14/997,436

(22) Filed: Jan. 15, 2016

(51) Int. Cl. A01K 63/06; F21V 23/06; F21S 4/26; F21V 23/04; F21V 23/00

(52) U.S. Cl. CPC A01K 63/06; F21V 23/0435; F21V 23/003; F21S 4/26; F21V 23/06; F21Y 2115/10; F21Y 2103/00

(57) ABSTRACT

The preferred embodiment of the inventive lid has parallel primary layers separated by a plurality of longitudinal supports. The primary layers and supports are preferably constructed from a clear polycarbonate. Side-by-side supports create a plurality of longitudinal cells. An LED light system is operably configured to pass light through the lower primary section into the aquarium.

### BACKGROUND OF THE INVENTION

The present invention relates generally to the care and rearing of small pets including fish that live inside an aquarium enclosure typically constructed of glass or other see-through material. In a preferred embodiment hereof, the present invention relates generally to raising small pets inside a glass aquarium, including tropical and saltwater fish, and the uncommon or exotic pet such as pet frogs.

An aquarium is particularly useful for raising small pets and fish because of the transparency of the glass, stability, availability, and low cost among other reasons. Aquariums come in a variety of sizes and configurations. The most common are the ten (10), twenty (20), fifty-five (55), one hundred and twenty-five (125) gallon aquariums often called “fish tanks” or “tanks”.

A common drawback to using an aquarium for small pets, other than fish, is the unavailability of a suitable lid for the tank enclosure. The common fish tank cover is in the form of a hood with at least one door and an incandescent light, but the fitment to the aquarium is loose and the profile is usually many inches above the top plane formed by the tank opening. There are many fish tank hoods equipped with lights and hinged doors to give access to the water within, but such hooded lids are not sufficiently secure for non-fish pets and allows for too much water evaporation in the pet fish application.

For non-fish pets, there are lids constructed of a planar screen positioned with a frame. The frame has a flange that fits over the periphery of the tank opening enabling the screen to span and cover the planar opening of the aquarium, while allowing free air flow into and out of the enclosure. Of course, the preferred screen is of a mesh size to prevent the pet and any live food from escaping. A common drawback with these types of lids is they cannot maintain humid or liquid environments within the enclosure unless the screen is covered. A covering for the mesh is a second piece of equipment, and usually ill-fitting to maintain sufficiently high humidity levels or keep the water inside. Moreover, metal screens rust, and cannot keep pet frog foodstuffs such as flightless fruit flies and pinhead crickets inside the enclosure, both of which are small enough to escape the enclosure through the commercially available screen lid.

Of course the owner of the enclosure can have a fitted sheet of glass or clear plastic such as polycarbonate, or LEXAN®, etc., made or cut to size to fit on the lip of the fish tank to effectively cover the opening. Unfortunately, these single layer see-through materials have their own drawbacks. Glass breaks and splinters, polycarbonate warps severely in high humidity applications, and LEXAN® is very expensive and difficult to machine. In addition, all of the single layer available covers do not sufficiently insulate to keep the fish water warmer longer, and the interior temperatures of exotic pet enclosures above ambient.

Equally important as the structural integrity of the lid is its venting capability if live pants are growing within the aquarium enclosure in the vivarium application, because airflow helps plants grow. Of course, all of the single piece and multiple piece sliding panel setups could be drilled to allow airflow, or cover less than the entire opening, however any sliding fitment is also always a challenge and is very difficult to maintain consistent humidity. Moreover, their single thickness structure allows for easy heat transmission into the vivarium from adjacent light systems and such increased heat and related fluctuations is not desirable.

An example of exotic pets is the pet frog such as pet dart frogs. They have skin that dries easily and humidity levels must be kept relatively high within the enclosure (e.g. typically 65-100%). (It is important to note, the captive bred pet dart frog is considered completely harmless because the toxins in wild dart frogs are from poisonous plants consumed by the very insects the frogs eat in the wild. As such, wild dart frog toxins are from poisonous insects in the wild. In captivity, pet dart frogs are fed harmless foods such as melanogaster fruit flies or tiny pinhead crickets, etc., and they are harmless.)

Using the preferred fish tank vivarium enclosure very well-suited for raising and breeding captive, non-toxic, pet dart frogs such as the SAFE® pet frogs bred and raised by USA Frog of Bartlett, Tennessee, the humidity levels need to be within a 65-100 percent range, and temperatures should not exceed 80 degrees or drop below about 70 degrees for very long. In such case, like the fish tank use, the preferred lid must therefore be structurally stable, virtually unbreakable and non-warping, enable a light source to rest thereon and preferably be incorporated therein, and light to pass therethrough while insulting the vivarium from introduced. The tight closure of the planar opening of the aquarium by the inventive lid also prevents escape of the pet enclosed therein and creates a planar shelf for storage of various articles like food containers, etc.

An effective pet lid for a fish tank or fish tank vivarium having live plants growing therein must: 1.) prevent pet escape, 2.) be sufficiently tight to promote and maintain high humidity and minimize evaporation, 3.) enable air circulation to promote plant growth or gaseous flow, 4.) be sufficiently strong to incorporate or support a light source and cast the light emitted from, through, or from within the lid into the enclosure to encourage plant growth and pet/fish health; 5.) while minimizing heat fluctuations from light systems or incompatible ambient temperatures; 6.) be somewhat transparent and high strength (i.e., highly resistant to warping, non-splintering like glass, or rust, etc.).

Until now a lid for a fish tank that is low cost, lightweight, high strength, tightly sealing, vented, insulating, somewhat see-through, capable of maintaining high humidity and preventing evaporation while minimizing temperature fluctuations in hot, cold, wet, or dry ambient (outside) conditions has not been invented. Also, until now, an illuminated fish tank lid that is low cost, lightweight, high strength, tightly sealing, vented, insulating, somewhat see-through, capable of maintaining high humidity and preventing evaporation while minimizing temperature fluctuations in hot, cold, wet, or dry ambient (outside) conditions has not been invented.

With respect to lighting and illumination generally, the LED and SMD are far superior to any incandescent or fluorescent lighting. LED bulbs are the only truly Eco-friendly lighting solution. Unlike traditional forms of lighting where the majority of the electrical energy is given off in the form of heat, LED bulbs operate at around 80% efficiency. This means that an LED bulb converts 80% of its electricity into light energy with very little given off as heat, compared to an incandescent bulb that only turns 20% of the electricity it uses into light energy.

LED lights are, therefore, some of the latest technology in energy efficient lighting. LED stands for ‘Light Emitting Diode’, a semiconductor device that converts electricity into light. SMDs or Surface Mounted Diodes are the new generation of LED lighting. Specifically, it's a light-emitting diode that is mounted onto and soldered onto a circuit board. An SMD LED is quite small since it has no leads or surrounding packaging that comes with a standard LED. This means it's best handled, not by a human, but by automated assembly equipment. An SMD LED also has a wide viewing angle, thanks to the fact that it does not have the standard LED's epoxy enclosure that focuses the beam. SMD LEDs are sized as a 3528 or a 5050. The numbers refer to the size of the SMD chips. 3528 means the chip size is 3.5 mm×2.8 mm. 5050 means the chip size is 5 mm×5 mm.

Typically, the LED temperature itself may be hot to the touch, but not nearly as hot as incandescent, halogen and compact fluorescent (CFL) bulbs. The LED heat is dissipated by metal heat sinks that take away the heat from the light source itself. Keeping them cool helps maintain the long lifespan of the LED bulbs. With respect to LED lifespan, when the working temperature is less than 25C (25 Celsius), the lifespan is typically 100,000 hours. When the working temperature is between 25C to 50C degrees, the lifespan is 50,000 hours. When the working temperature is between 75C to 100C, the lifespan is 10,000 hours. When the working temperature is between 125C to 150C degrees, the lifespan is 2,000 hours. The pet lid applications are typically 25C and below.

### SUMMARY OF THE INVENTION

The present invention includes: 1.) a lid for commercially available (and custom) fish tanks, 2.) a fish tank fitted with the inventive lid, including an illuminated embodiment thereof, as well as 3.) a kit for building a vivarium with the inventive lid, and 4.) a shipper useful for delivering the aforementioned components via any number of commercially available couriers services, and the U.S. Postal Service.

The inventive lid is particularly useful for the captive raising and breeding of pets, including fish, frogs, mammals, reptiles, or any other pet in a fish tank vivarium. Captive bred dart frogs make great pets, for example, but they require warm, humid, temperature and humidity stable environments with plenty of ground cover to thrive. A properly fitted dart frog vivarium made from a fish tank includes live plants and microlife living in the plant growing substrate and decaying leaf litter in order to establish a sustainable ecosystem for removing organic frog waste, food scraps, natural micro-molds common to growing media and soils, etc. The plants within the tank also serve as a “jungle gym” for the frogs and necessary vegetation for consistent humidity throughout.

Equally important for success is a thick layer of dried leaf litter placed on top of the soil. The plants and leaves tend to mimic the ground of their natural frog rain forest habitats where humidity is naturally high in the aforementioned levels. The inventive lid disclosed and claimed herein helps create a captive frog environment very similar to the wild and is particularly useful for cycling the dart frog enclosure between wet and dry “seasons” to mimic natural rain forest conditions known to promote frog breeding, and healthy frog behavior overall.

The preferred embodiment of the inventive aquarium lid has two primary layers separate by a plurality of longitudinal supports. The primary layers are preferably two parallel planar sheets of a substantially clear polycarbonate material secured together by at least one support. One of the two primary layers is in communication with the inside of the enclosure (the bottom-most surface), and the other is in communication with the outside thereof.

The support(s) of the preferred embodiment are longitudinal ribs interpositioned between the spaced apart and generally parallel primary layers. In a preferred embodiment, the plurality of supports are side by side to create a plurality of longitudinal cells spanning the length of the lid section(s). In cross-section, and looking at the end view, the cells are plainly visible and yet they run the length or width of the lid depending upon the embodiment orientation with respect to the enclosure. In this configuration the innermost preferably polycarbonate layer is in contact with higher humidity interior of the enclosure, but it does not warp because of the support walls and opposing primary layer that is attached thereto and preferably formed integral therewith.

The cellular structure of the present invention minimizes heat from passing through the lid into the enclosure in much the same way a multi-pane window is also insulating. For optional venting, at least one aperture maybe formed in the lid and preferably through the lowermost primary layer only. This allows the internal gaseous atmosphere of the fish tank enclosure to be vented (in communication with ambient conditions) through the aperture(s), into the cell(s), and outside to the atmosphere for proper venting. The most preferred embodiment(s) have a plurality of vent holes (i.e., vents) in the lowermost primary layer. The number of open vents is preselected by the user to maintain their desired humidity within the enclosure no matter how many plants are living therein, or where it is stored within the household, museum, school, etc. To reduce the number of vents and decrease the gaseous communication of the interior of the tank vivarium, the cell(s) and the outside atmosphere, the user may place a common piece of tape over the desired number of aperture(s) in the lower primary layer as this minimizes venting. Opening the vent(s) by removing the tape and exposing the vent hole(s) increases gaseous communication between the interior of the vivarium tank and the outside atmosphere.

In the simplest embodiment, the wall assembly of the pet enclosure aquarium further comprises a rim and lip enabling the lower primary layer to rest on the lip. The lowermost primary layer may have an optional strip of adhesive applied to at least a portion of the periphery of the lowermost layer/surface. The adhesive sticks to the lip of the fish tank to secure the lid section thereto. While single section inventive lids are useful, the preferred embodiment has a plurality of sections, i.e., two or more sections joined by a hinge. A two section lid included two upper and lower primary layer pairs. The sections are positioned closely side-by-side and jointed by a hinge. A preferred hinge is a strip of high strength clear packing tape to secure and hinge the opposing adjacent sections together. In this way, only one of the sections need have the adhesive to secure it to the fish tank while the other is easily lifted for access to the inside of the tank for feeding, etc.

The preferred cell geometry viewed from the end is typically 4-20 mm and square, rectangular, triangular or just about any parallelepiped shape. Of course other geometries are also contemplated and included within the spirit of the invention set forth herein. When using an embodiment having a support of 6 mm or more to separate the opposing upper and lower primary layers while operably positioned on the rim resting atop the fish tank wall assembly and lip protruding inside of the fish tank vivarium, the upper layer may rise above the uppermost portion of the rim. This configuration promotes better airflow and heat exchange from the inside to the outside of the enclosure and vice versa in the vented embodiment. As a higher internal atmospheric pressures are created by the “heat of the day” within the enclosure, the internal air escapes faster through some of the optional vents while any micro-vacuum created thereby allows for fresh air to be introduced through some of the vent holes in the reverse flow direction to establish a consistent, continually regulating equilibrium inside the enclosure. Of course, in the unvented fish tank or high humidity embodiments, humidity loss and evaporation are minimized.

Accordingly, the present invention may be summarized as follows: An inventive lid for a pet enclosure having a wall assembly, a bottom, and an open top defining an inside and an outside. The inventive lid further comprises an upper primary layer and a lower primary layer joined to the upper primary layer forming at least one cell in communication with the atmosphere outside of the enclosure. An optional vent may be formed through the lower primary layer enabling gaseous communication between the inside of the pet enclosure, the cell, and the atmosphere outside the enclosure. The preferred lighting system of the present invention is LED strip lighting more thoroughly described below.

At least one support is provided to join the upper and lower primary layers and define a cell. A plurality of supports defining a plurality of cells is preferred. The lower primary layer preferably includes a plurality of vents enabling gaseous communication between the inside of the pet enclosure, more than one of the plurality of cells, and the atmosphere outside the enclosure.

The preferred embodiment of the inventive lid may have a left and right section and any number of middle sections therebetween. Either of the preferred left and right sections may pivot upward and away from the aquarium vivarium to provide ease of access to the inside. A hinge is operably attached to the at least two left and right sections for enabling the left or right section to pivot with respect to the other. With respect to the embodiments that have more than one section that comprises the entire lid, a means to secure one of the sections to the top rim of the aquarium secure placement of the lid and ease of access to the inside.

Of course, the supports may be longitudinal ribs that have a hidden centerline such that at least two of the centerlines of the plurality of longitudinal ribs are parallel with one another. While not mandatory, a plurality of supports is desired. The preferred supports are longitudinal ribs forming a right angle with the upper primary layer and lower primary layer, but any rib may forma diagonal (not shown) for additional strength.

The present invention may also be summarized as follows: a pet enclosure and lid combination, comprising: an aquarium having a wall assembly, a bottom, and an open top defining an inside and an outside; a lid configured to fit at the top of the aquarium to cover the inside, wherein the lid further comprises an upper primary layer and a lower primary layer joined together to form at least one cell therebetween. Optional vents may be formed through the lower primary layer enabling gaseous communication between the inside of the pet enclosure, the at least one cell, and the atmosphere outside the enclosure. A shipping container configured to receive the aquarium and kit (a “shipper”) is also available.

Yet again, the present invention may also be summarized as follows: a lid for an aquarium having an inside and an outside and an upper rim, comprising: a lid having spaced apart upper and lower primary sections joined together by at least one support to form at least one cell between the upper and lower sections, wherein: the lower primary section covers the inside of the aquarium. An LED strip tape light system is mounted to the lid to illuminate the interior of the aquarium. An optional vent maybe formed in the lower primary section to enable gaseous communication between the inside of the vivarium, the cell, and the atmosphere outside the aquarium.

Thus, the preferred embodiments of the present invention may also be described as follows: an enclosure lid, comprising: an upper primary layer; a lower primary layer; a plurality of longitudinal supports for rigidly securing the upper layer to the lower layer and forming a plurality of cells therebetween; and a LED strip light operably positioned within at least one of the plurality of cells for generating light capable of passing through the lower primary layer to illuminate the interior of the enclosure.

The LED strip may be operably positioned within more than one of the cells, and the upper and lower primary layers may further comprise at least two distinct front and back sections positioned in close proximity to one another; and a hinge means operably attached to the back section for pivotally securing the front section to the back section.

A non-pivoting section may be secured to a rim of the aquarium in a stationary manner thereby enabling the unsecured section to pivot between an open and closed position.

Of course, the LED strip may be a SMD LED of a 3528 or 505 configuration. The light may be daylight white light, RGB colored light, or high intensity light well-suited for saltwater aquarium applications. A remote or smart phone control may also be used. The remote is preferably wireless and capable of controlling color hue and intensity including duration. The smart phone software performs more complicated controls such as sunrise to sunset lighting.

The vivarium kit that includes the inventive lid also preferably includes at least one of the following: a drainage layer material, a partition configured to overlay the drainage layer, a substrate to be placed on top of the partition, a quantity of leaf litter to be placed on top of the substrate, at least one plant having a root mass to be positioned substantially within the substrate.

The preferred illumination for the inventive lid herein described and claimed includes a plurality of daylight or cool white configuration with a 6000K rating. SMDs are three times brighter than the older LEDs. LED bulbs with SMDs generate a high quality light the same color as normal household bulbs, or full spectrum daylight. Still, other high intensity LED applications are contemplated including those that use high intensity LED lights with a much greater Kelvin rating than 6000K. High-Intensity lighting emits bright light with a high color temperature (Kelvin-rating) usually ranging from 10, 000° K to 20, 000° K. 20, 000° K bulbs will emit a brilliant white-blue light that appears “cooler” to simulate deeper marine light conditions. These high intensity LED applications are particularly useful for saltwater aquarium applications where exotic corals have particular lighting requirements in the higher K ranges.

The lifespan of LED lights can be adversely affected by severe changes in working temperature or operating the bulbs outside the recommended temperature range. LED bulbs are tested at a working temperature of 25 degrees Celsius (77 degrees Fahrenheit). Because the preferred SMD LED lighting is mounted with the cell of the inventive lid, the airflow through the cells allows for additional cooling and prolonged life.

More specifically, the preferred SMD LED lighting is a strip mounted within the longitudinal cells of the lid. A common adhesive or silicone caulk may secure the SMD LED strip within the cell. The wiring harness for the LED strip is external to the lid for ease of access and convenience. One of the preferred configuration of operating parameters of the SMD LED strip lighting partially comprising the inventive lid is as follows:

| LED Type | 5050 SMD LED |
|---|---|
| LED Quantity (Units/M) | 60 |
| Frequency (hz) | 60 |
| Switching Cycles | 50000 |
| Brightness (lm) | 720 lm/m |
| Input Voltage (v) | 110-120 AC |
| Certification | CE, RoHS |
| Color Temperature (K) | 6000 |
| Length (in) | 39.37 |
| Protection Rating | IP65 |
| Brightness (lm/m) | 720 |
| Rated lifetime (h) | 25000 |
| Warranty | 1 Year |
| Light Color | Daylight White |
| Width (in) | 0.55 |
| Shock Proof | Yes |
| Waterproof | Yes |
| Wattage (W/M) | 14.4 |

An alternate configuration may use 3528 SMD LED as follows:

| LED Type | 3528 SMD LED |
|---|---|
| LED Quantity (Units/M) | 60 |
| Frequency (hz) | 60 |
| Switching Cycles | 50000 |
| Brightness (lm) | 300 lm/m |
| Input Voltage (v) | 110-120 AC |
| Certification | CE, RoHS |
| Color Temperature (K) | 6000 |
| Protection Rating | IP65 |
| Brightness (lm/m) | 300 |
| Rated lifetime (h) | 25000 |
| Warranty | 1 Year |
| Light Color | Daylight White |
| Shock Proof | Yes |
| Waterproof | Yes |
| Wattage (W/M) | 4.8 |

Of course rope or other LED type lighting including and battery powered SMD LED configurations, or even hobby “rice lights”may also be used. For example, where special lighting affect are desired, dimmable and remote controlled multi-colored lights of the Red, Green, Blue, (RGB) configuration may also be used. An example of such colored lighting is as follows:

| | |
|---|---|
| LED Type | 5050 SMD LED |
| LED Quantity (Units/M) | 60 |
| Rated lifetime (h) | 25000 |
| Warranty | 1 Year |
| Input Voltage (v) | 110-120 AC |
| Certification | CE, RoHS |
| Width (in) | 0.55 |
| Shock Proof | Yes |
| Frequency (hz) | 60 |
| Switching Cycles | 50000 |
| Light Color | Multi-colored |
| Length (in) | 39.37 |
| Wattage (W/M) | 14.4 |
| Protection Rating | IP65 |
| Waterproof | Yes |

Various other embodiments, features, and advantages of the present invention will be made apparent from the following detailed description and the drawings.

### BRIEF DESCRIPTION OF THE DRAWINGS

The drawings illustrate one preferred embodiment presently contemplated for carrying out the invention. In the drawings:

FIG. 1 is an elevated view of a primary, preferably upper, layer of a preferred embodiment of the present invention.

FIG. 2 is an elevated view of a primary, preferably lower, layer of a preferred embodiment of the present invention.

FIG. 3 is an enlarged end view of a preferred embodiment of the present invention showing the preferred spaced apart parallel alignment of the primary layers of FIGS. 1 and 2 joined together with support walls forming a plurality of cells.

FIG. 4 is bottom view of the preferred embodiment shown in FIGS. A-B.

FIGS. 5 is an enlarged end view taken along section line 5-5 in the direction of the arrows of FIG. 4.

FIGS. 6 & 7 are enlarged end views of the slices designated by the transverse lines 6-6 and 7-7 of FIG. 4 respectively.

FIG. 8 is a bottom view of the hinged alternate embodiment shown in FIG. 15.

FIGS. 9 and 10 are side views of the alternate embodiment show in in FIG. 8 and C illustrating the closed (planar) position (FIG. 9), and open (angled) position (FIG. 10).

FIGS. 11 and 12 are ends views of the primary layers formed from a single sheet bent approximately in half (FIG. 11); and formed as a single rectangular flattened box (FIG. 12) each with a single cell.

FIGS. 13 and 14 are elevated perspective views of an embodiment of the present invention shown in FIGS. 1-3.

FIG. 15 is an elevated perspective view of a preferred embodiment shown in communication with an aquarium style vivarium.

FIG. 16A is an elevated perspective photograph of the lid shown in communication with an empty fish tank enclosure.

FIG. 16B is an elevated perspective photograph of the lid shown in communication with side-by-side fish tank enclosures.

FIG. 17 is front planar photograph of the inventive lid with a hinge line, but without the lighting system described and claimed herein.

FIGS. 18 and 19 are elevated perspective photographs of the edge of the inventive lid illustrating the plurality of cells in which the preferred embodiment of the lighting system is installed.

FIGS. 20-33 illustrate some of the preferred embodiments of the SMD LED lighting system of the inventive lid.

FIG. 20 is an elevated perspective photograph of a spool of the preferred led strip lighting in daylight (cool) white with power supply.

FIG. 21 is an elevated perspective photograph of a spool of the preferred led strip lighting in RGB color with multiple power supplies.

FIG. 22 is an elevated perspective view of the power supplies of FIGS. 20 and 21

FIG. 23 is an enlarged top view of a strip portion of the preferred SMD LED spools of FIGS. 20 and 21.

FIG. 24 is an elevated perspective photograph collage of the RGB color emissions from the single spool of FIG. 21.

FIG. 25A is an elevated perspective photograph of an embodiment of a remote control for use with the inventive lighting system portion of the inventive lid.

FIG. 25B is a representative color triangle illustrating how the color hue variations are achieved by the electronics for the remote of FIG. 25A and SMD LED of FIGS. 23 and 21.

FIGS. 26R, 26G, 26B, 26Y and 26W are elevated close-up photographs of the RBG powered SMD LED of FIGS, 21, 23, and 25A-25B.

FIGS. 27-33 are elevated perspective photographs of the preferred lighting system installed within the inventive lid. The strip SMD LED could be attached directly to the outer surface of the inventive lid, such as the lowermost surface of the bottom primary layer, with a suitable adhesive or mechanical mounting structure to prevent detachment of the lighting strip from the lid as shown in FIG. 27.

Other preferred, alternate, and/or equivalent embodiments to those shown in the figures are contemplated within the scope of the present invention as claimed.

### DETAILED DESCRIPTION OF THE PREFERRED EMBODIMENT(S)

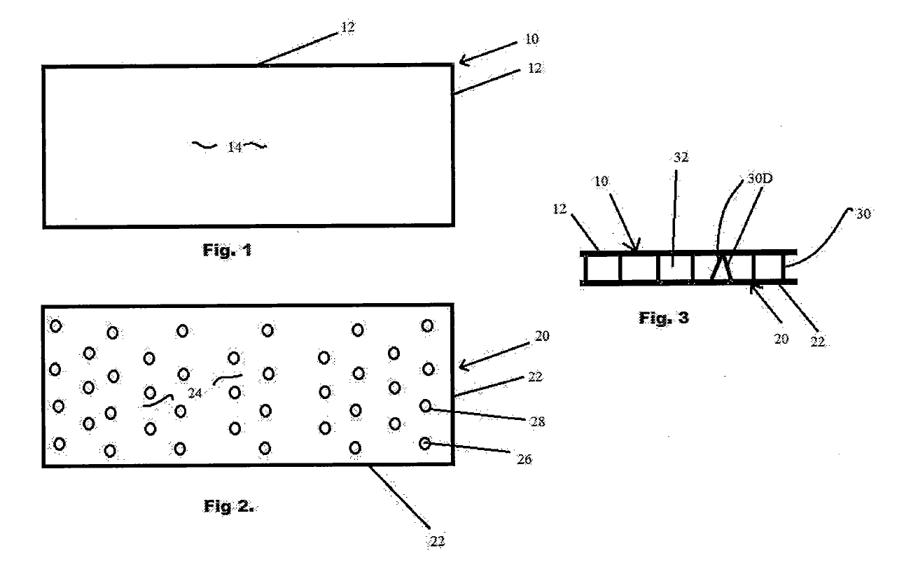

With reference to FIGS. 1-3, a primary layer is designated generally by the reference numeral 10. The primary layer has an edge 12 and primary surface 14. The preferred embodiment of the present invention contemplates the use of two (2) primary layers in communication with each other. A second primary layer designated by the reference numeral 20 (FIG. 2) has an edge 22, primary surface 24, a plurality of vents (shown as apertures) 26 with aperture boundary 28. The primary layers 10 and 20, as well as the surfaces 14 and 24, can be formed in a single piece of material such as a rectangular section of polycarbonate bent or formed to have a pair of substantially parallel surfaces held in the proper alignment by a support (see FIGS. 11 and 12 discussed in more detail below) like that discussed with respect to FIG. 3.

With reference to FIG. 3, a preferred arrangement of a primary layer 10 and primary layer 20 is shown. As viewed from an edge 12 and 22, a plurality of supports 30 form a right angle with the preferred primary layers 10 and 20 top keep them in a spaced apart relationship defining a plurality of cells 32. The size and configuration of the cells may all be the same, or vary. Similarly, the supports may be diagonal supports (30-D) for added strength with respect to the upper and lower primary layers (see FIG. 3.).

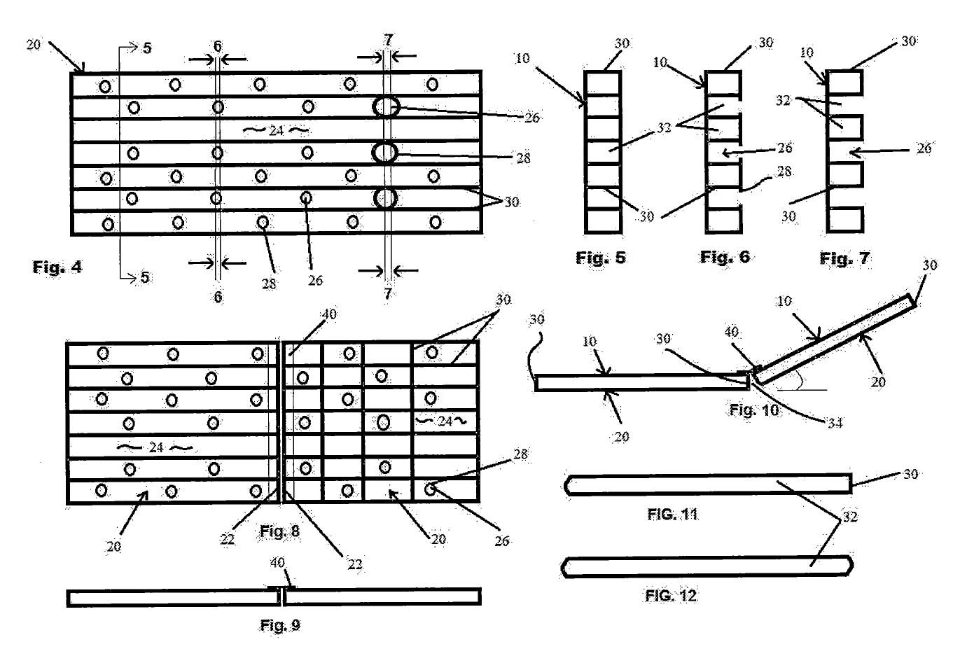

With reference to FIGS. 4-7, a lower primary layer 20 is illustrated. Section cut line 5-5 corresponds to FIG. 5. Slices 6-6 and 7-7 correspond similarly to FIGS. 6 and 7 respectively. The supports walls of FIGS. 4-7 are visible through the lower primary layer surface 24 indicating it is preferably translucent, and the longitudinal supports span the length of the lid sections, however, the longitudinal supports may just as easily run transverse to the length of the lid sections, and such orientation is well within the scope of the present invention (see FIG. 8). FIGS. 5-7 representatively illustrate a plurality of supports 30 defining a plurality of cells 32. The vent apertures 26 (vents) are shown with boundary walls 28 defining the size of the vent. The vents 26 may span the width of the cells, or any other dimension.

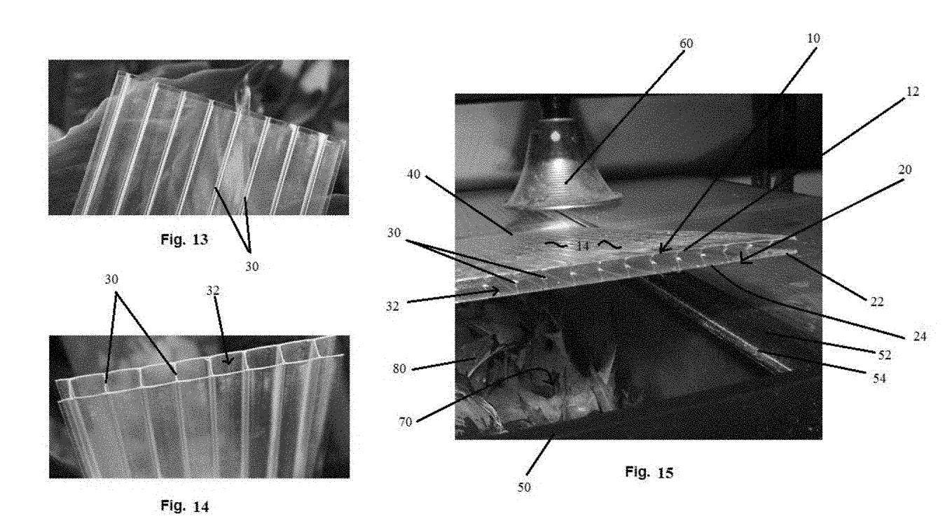

With reference to FIGS. 9-12 and 13-15 and the elevated perspectives views thereof, supports 30 separate an upper primary layer 10 and lower primary layer 20 (FIG. 15). Supports 30 may not form a right angle with the upper or lower primary layers as viewed from the edges 12 and 22 thereof. Cells 32 are illustrated as longitudinal because the supports 30 are longitudinal ribs that span the length of the primary layers. Lower primary layer 20 has a lowermost underside surface 24 that contacts the rim 52 of the empty fish tank (aquarium) designated by the reference numeral 50. Rim 52 has a protruding lip or ledge 54 on which a portion of the underside surface 24 rests.

In FIG. 15 the preferred embodiment shown therein comprises more than one section, e.g., left and right sections, or front and back sections depending upon the point of reference. Three or more sections are also within the scope of the present invention. For ease of reference, the elevated section opens the vivarium to reveal the inside 70 and plants 80 growing therein. Heat source 60 is adjacent an uppermost surface 14 and a hinge 40 (more readily visible in FIGS. 8-10). Of course, while the hinge is not mandatory, the use of a hinge helps establish the proper gap spacing 34 (FIG. 10), and maintain multiple sections in proper alignment when opened and closed during use.

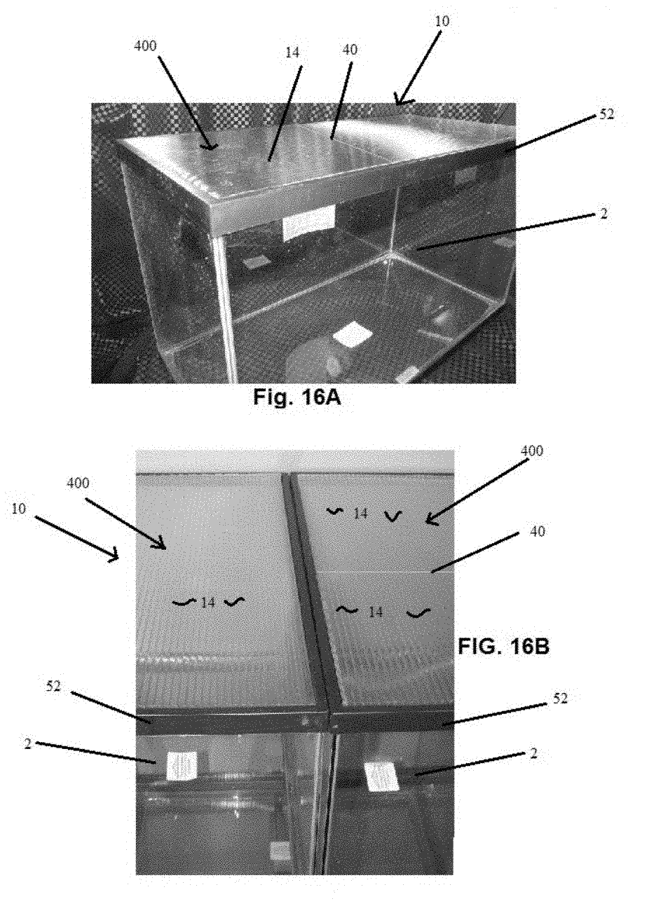

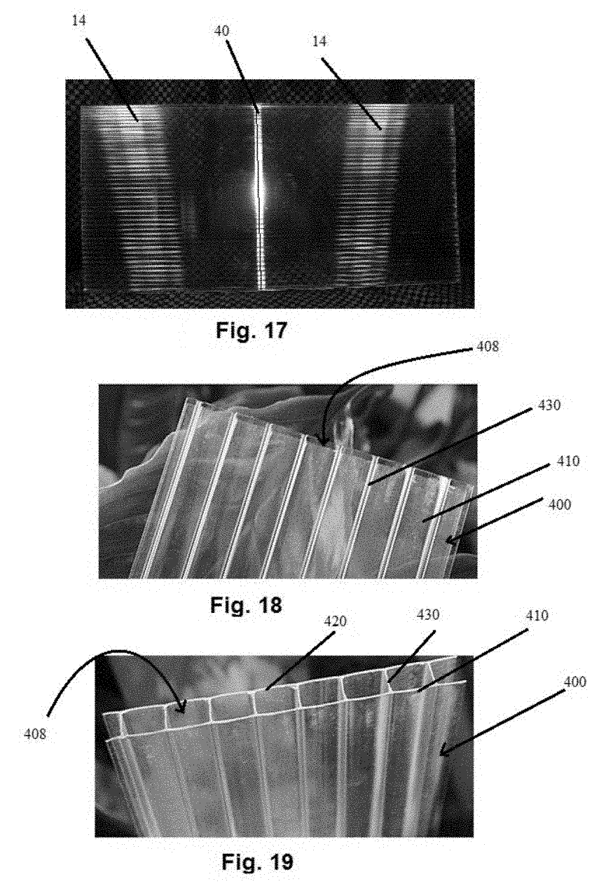

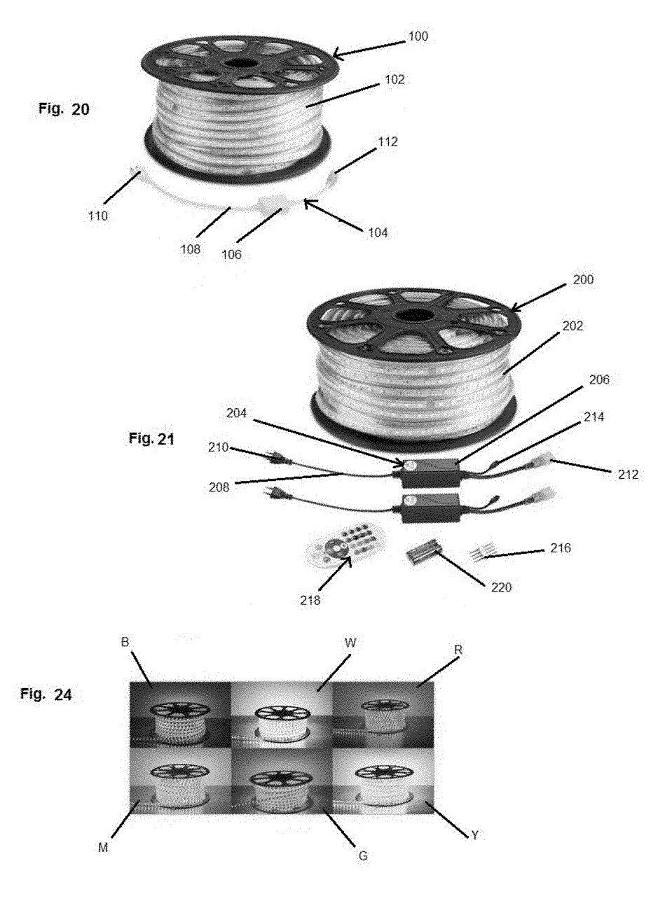

With reference to FIGS. 16A-16B and 17, a fish tank enclosure is designated generally by the reference numeral 2 having rim 52. An alternate embodiment of the inventive lid is designated generally by the reference numeral 400 and will be used in combination of the remaining Figures to fully illustrate the inventive lid outfitted with an illuminating system described below in its preferred embodiments. Similar to the earlier Figures (FIGS. 1-12), lid 400 is shown having a top primary layer 10 with uppermost surface 14 and optional hinge 40 enabling the left or right, front or back, section to pivot between an open and closed position. With reference to FIGS. 18-19, lid 400 has spaced apart primary layers 410 and 420 held in rigid communication with one another by a plurality of longitudinal supports 430 defining cells 408 in which the preferred lighting system is installed (FIGS. 20-24).

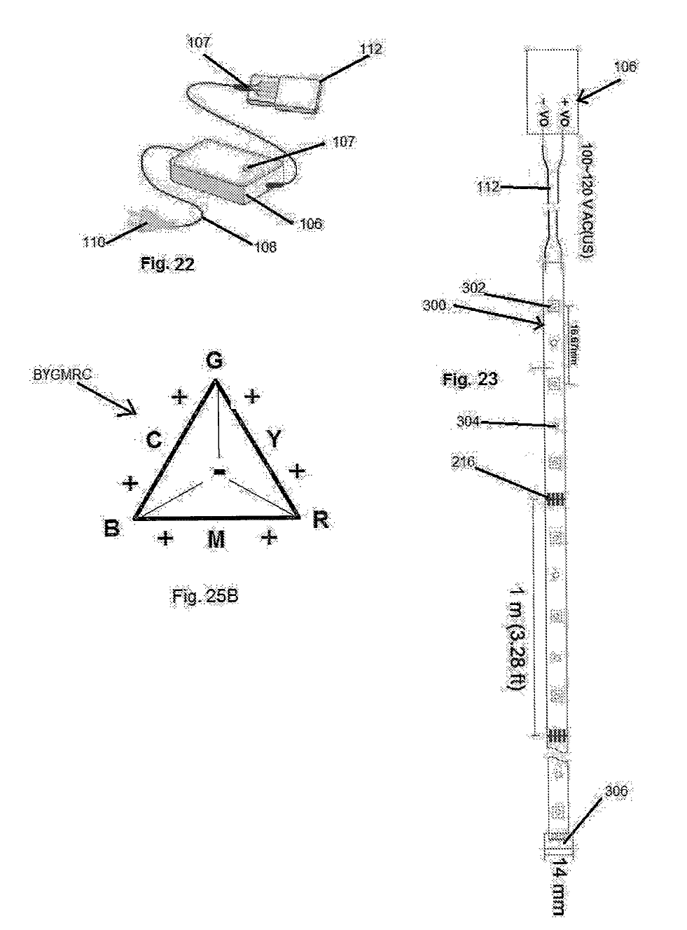

With reference to FIGS. 20-24, spools of led strip lighting designated generally by the reference numerals 100 and 200 are shown (FIGS. 20 and 21). The preferred SMD LED lighting resembles a long tape 102 and 202. For ease of reference, LED tap 102 is a daylight or cool white, and tape 202 is Red-Green-Blue (RGB) capable of virtually infinite colors production. Power supplies 104 and 204 (also shown in FIG. 22), include power box 106 and 206, power cord 108 and 208 fitted with a household plug 110 and 210. Opposite the cord 108 and 208 is wiring harness 107 (FIGS. 22), 112 and 212 (FIGS. 20 and 21) configured to operably engage the SMD LED strip lighting as shown schematically in FIG. 23. Wiring harness 112 (and 212) power the LED segment designated general y by the reference numeral 300 in FIG. 23. LED segment 300 includes a plurality of diodes 302 and resistors 304. The diodes 302 are preferably surface mounted diodes (SMD LED) variety of either the 3528 or 5050 configurations. Pin connectors 216 (FIGS. 21 and 23) are used to operably interconnect individual strips of LED tap. End cap 306 closes the end of the strip 300.

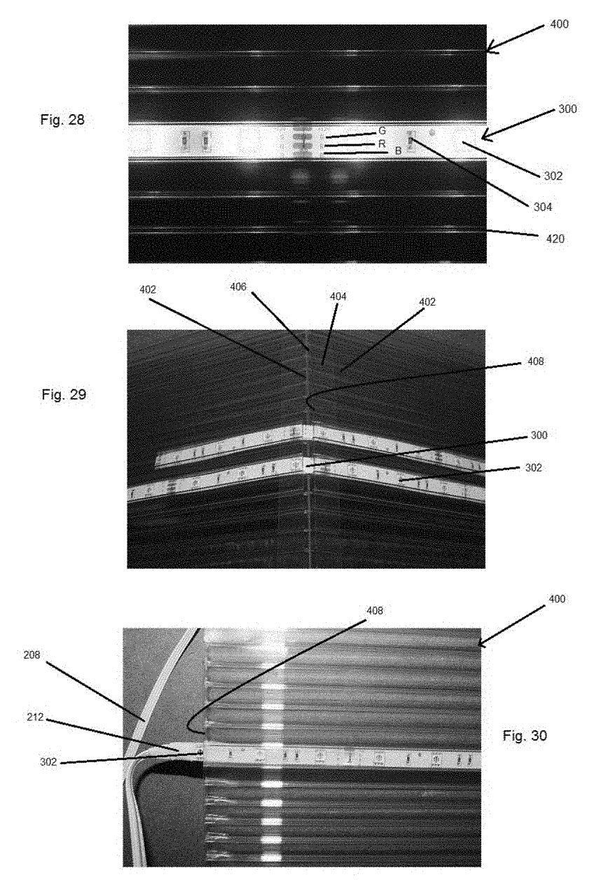

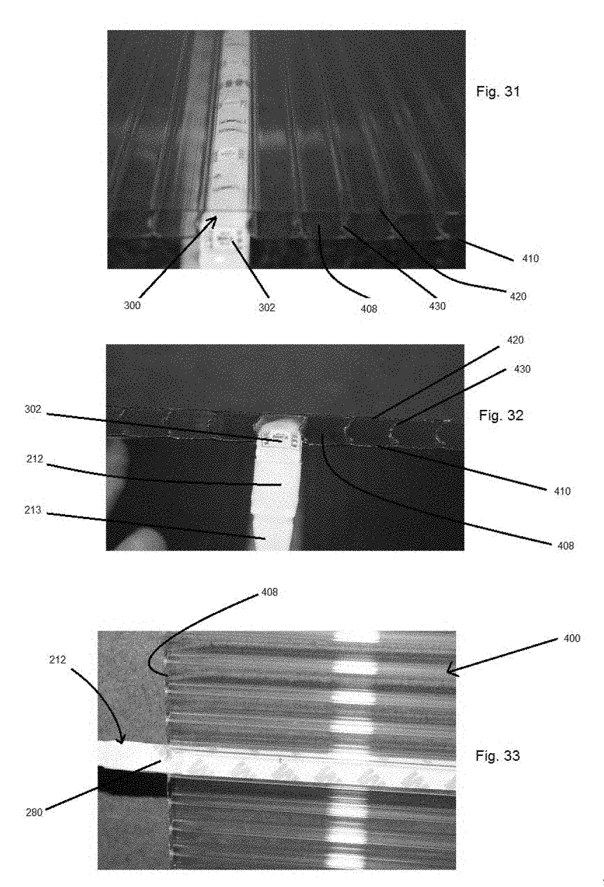

With reference to FIGS. 28-33, the LED strip 300 is installed within the longitudinal cell 408 formed by the spaced apart primary layers 410 and 420 and held in rigid alignment with supports 430. The LED strip is also flexible and capable of spanning a hinged joint 406 (FIG. 29).

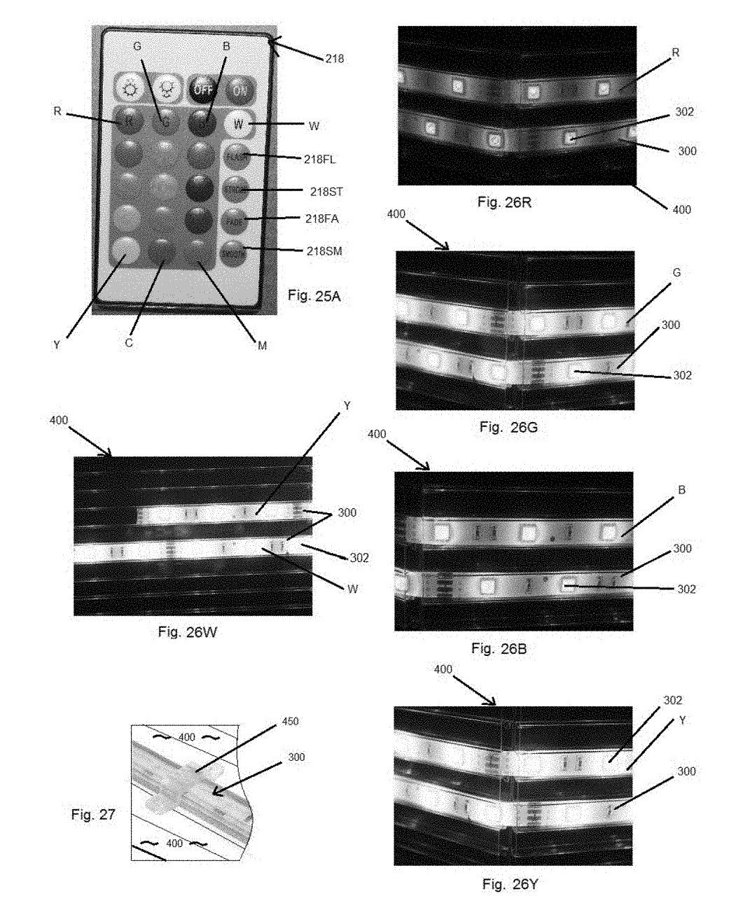

For sophisticated applications, as in the saltwater aquarium or sunrise to sunset automated control of the color hues by a smart phone application as the remote, where colors changes and the timing variability (duration) thereof are virtually infinite, the inventive lid may use wireless remote such as a smart phone with automated software control. With reference to FIGS. 21, 24 25A-25B, and 26R, 26G, 26B, 26Y, and 26W, the LED strip 300 of the RGB variety 302 (or other variety such as that shown as 102 of FIG. 20) is controlled by a remote designated generally by the reference numeral 218 powered by batteries 220. Of course, the remote may be replaced with a smart phone remote capability and maintain the same function of controlling ON/OFF, Brightness, and visual effects such as flash (218FL), strobe (218ST), fade (218FA), and smooth (218SM) of FIG. 25A. Of course, all of the Red, Green, Blue, Yellow, Cyan, and Magenta (R, G, B, Y, C, M, respectively of FIGS. 25A and 25B are controllable. The graphic shown as FIG. 25B, designated generally by the reference BYGMRC indicates the nature of the electronic control to alter the color hues. To increase red R, the electronics will decrease cyan C, or increase magenta M and yellow Y. Similarly, for the electrics to decrease green G, an increase of magenta M, or decrease of cyan C and yellow Y can have the same result as they are related. FIGS. 26R, 26G, 26B, 26Y and 26Y depicts the colors emitted by the same LED strip installed within the inventive lid 400. Each Figure shows a plurality of diodes 302 and color B, Y, G, R, or W. Of course, in a less preferred, but useful embodiment, the LED strip 300 is attached to the surface of the lid 400 with an adhesive (not shown in this view) or a plurality of mounting brackets 450 (only one shown) (see FIG. 27).

What is claimed is:

1. An enclosure lid, comprising:
an upper primary layer;
a lower primary layer;
a plurality of longitudinal supports for rigidly securing the upper layer to the lower layer and forming a plurality of cells therebetween; and
a LED strip light operably positioned within at least one of the plurality of cells for generating light capable of passing through the lower primary layer to illuminate the interior of the enclosure.

2. The lid of claim 1, wherein:
the LED strip is operably positioned within more than one of the cells.

3. The lid of claim 1, wherein the upper and lower primary layers further comprise:
at least two distinct front and back sections positioned in close proximity to one another; and
hinge means operably attached to the back section for pivotally securing the front section to the back section.

4. The lid of claim 3, further comprising:
securing means for securing the back section to a rim of the aquarium in a stationary manner thereby enabling the unsecured front section to pivot between an open and closed position.

5. The lid of claim 4, further comprising:
at least one middle section interpositioned between the front and back sections; and
the hinge means enables the front or back section to pivot between an open and closed position.

6. The lid of claim 1, wherein:
the LED strip is a SMD LED.

7. The lid of claim 6, wherein:
the SMD LED strip is either a 3528 or 505 configuration.

8. The lid of claim 1, wherein:
the SMD LED strip produces daylight white light.

9. The lid of claim 1, wherein:
the SMD LED strip produces RGB colored light.

10. The lid of claim 1, wherein:
the SMD LED strip produces high intensity light well-suited for saltwater aquarium applications.

11. An aquarium lid, comprising:
an upper primary layer and a lower primary layer joined to the upper primary layer forming at least one cell interpositioned between the upper and lower layers; and
an LED strip light operably positioned within the at least one cell to generate light capable of passing through the lower primary layer to illuminate the interior of the aquarium.

12. The lid of claim 11, further comprising:
a plurality of longitudinal supports for joining the upper and lower primary layers to form a plurality of cells, and the LED strip light is installed within a plurality of the cells.

13. The lid of claim 11, wherein the upper and lower primary layers further comprise:
at least two distinct left and right sections positioned in close proximity to one another; and
hinge means operably attached to the at least two left and right sections for enabling the left or right section to pivot with respect to the other.

14. The lid of claim 13, further comprising:
securing means for securing the left or right section to a rim of the aquarium in a stationary manner thereby enabling the unsecured left or right section to pivot with respect to the stationary section.

15. The lid of claim 14, further comprising:
at least one middle section positioned between the left and right sections; and
the hinge means further comprises a left hinge for pivotally securing either the left or right section to the at least one middle section.

16. The lid of claim 15, further comprising:
securing means for securing at least one of the left, right, or middle sections to the rim of an aquarium.

17. The lid of claim 11, further comprising:
remote means for wireless control of the color hue and intensity including duration.

18. The lid of claim 17, wherein the remote means is:
a smart phone with enabled software for automatic control.

19. The lid of claim 11, wherein:
the LED strip is a SMD LED.

20. The lid of claim 19, wherein:
the SMD LED strip is either a 3528 or 505 configuration.
